(19) United States
(12) Patent Application Publication
(10) Pub. No.: US 2026/0142529 A1
(43) Pub. Date: May 21, 2026

(54) MOTOR COOLING FLUID DISTRIBUTION STRUCTURE

(71) Applicant: GM Global Technology Operations LLC, Detroit, MI (US)

(72) Inventors: Jeffrey A. Schlautman, Lapeer, MI (US); Aleksandr Vartanian, West Bloomfield, MI (US); Carolyn Ann Schupra, Rochester Hills, MI (US)

(21) Appl. No.: 18/954,773

(22) Filed: Nov. 21, 2024

(51) Int. Cl. H02K 9/19; B60L 50/60

(52) U.S. Cl. CPC H02K 9/19; B60L 50/60

(57) ABSTRACT

A motor assembly for a vehicle includes a stator assembly having windings, a cooling fluid conduit configured to supply cooling fluid to cool the windings, and a motor cooling fluid distribution structure. The motor cooling fluid distribution structure includes a deflection structure disposed above at least a portion of the windings. The deflection structure includes an impact surface configured to receive the cooling fluid from the cooling fluid conduit to spread the cooling fluid. The deflection structure is configured to supply the cooling fluid spread by the impact surface to the windings.

The subject disclosure relates to vehicles, and in particular to a cooling fluid distribution structure for vehicle motors.

A vehicle motor generally includes a rotor and a stator with windings. As a vehicle motor may generate heat during operation, a cooling fluid may be introduced to different components of the vehicle motor. Improvements in cooling fluid distribution may be desirable.

### SUMMARY

In one exemplary embodiment, a motor assembly for a vehicle comprises a stator assembly comprising windings; a cooling fluid conduit configured to supply cooling fluid to cool the windings; and a motor cooling fluid distribution structure. The motor cooling fluid distribution structure comprises a deflection structure disposed above at least a portion of the windings. The deflection structure comprises an impact surface configured to receive the cooling fluid from the cooling fluid conduit and to spread the cooling fluid. The deflection structure is configured to supply the cooling fluid spread by the impact surface to the windings.

In addition to one or more of the features described herein, the cooling fluid conduit comprises a fluid outlet facing the impact surface.

In addition to one or more of the features described herein, wherein the deflection structure further comprises an upper wall above the impact surface and side walls on circumferential sides of the impact surface.

In addition to one or more of the features described herein, the upper wall comprises a lip on an end thereof.

In addition to one or more of the features described herein, the deflection structure extends circumferentially about at least a portion of the windings.

In addition to one or more of the features described herein, the deflection structure is an upper deflection structure disposed above an upper portion of the windings and is configured to supply the cooling fluid spread by the impact surface to the upper portion of the windings.

In addition to one or more of the features described herein, the motor cooling fluid distribution structure further comprises a lower deflection structure disposed above a lower portion of the windings and below the upper portion of the windings. The lower deflection structure comprises an impact surface configured to receive the cooling fluid from another cooling fluid conduit to spread the cooling fluid. The lower deflection structure is configured to supply the cooling fluid spread by the impact surface to the lower portion of the windings.

In addition to one or more of the features described herein, the motor cooling fluid distribution structure further comprises a gutter structure disposed below the upper portion of the windings. The gutter structure comprises a partial annulus structure configured to catch the cooling fluid from the upper deflection structure passing through the upper portion of the windings.

In addition to one or more of the features described herein, the deflection structure is shaped as a partial ring around the upper portion of the windings.

In addition to one or more of the features described herein, wherein the deflection structure comprises an outer body defining a partially enclosed space therein, and an inner body disposed within the partially enclosed space and defining the impact surface.

In addition to one or more of the features described herein, the impact surface is curved when viewed along a circumferential direction of the partial ring.

In addition to one or more of the features described herein, the outer body comprises a curved radial wall facing an edge of the impact surface.

In addition to one or more of the features described herein, a fluid inlet opening is defined through a wall of the outer body.

In addition to one or more of the features described herein, an outlet end of the fluid inlet opening faces the impact surface.

In addition to one or more of the features described herein, the deflection structure defines a partially enclosed space therein, with the impact surface defining at least a portion of the partially enclosed space. An opening configured to supply the cooling fluid to the windings is formed in the impact surface.

In addition to one or more of the features described herein, the impact surface comprises a recess configured to interrupt a surface tension of the cooling fluid

In addition to one or more of the features described herein, the cooling fluid conduit is coupled to the fluid inlet opening.

In addition to one or more of the features described herein, the cooling fluid conduit is configured to supply a fluid jet to the impact surface.

In another exemplary embodiment, a vehicle motor assembly comprises a stator assembly comprising windings, the windings comprising an upper portion and a lower portion; a first cooling fluid conduit configured to providing cooling fluid to cool the upper portion of the windings; a second cooling fluid conduit configured to supply the cooling fluid to cool the lower portion of the windings; and a motor cooling fluid distribution structure. The motor cooling fluid distribution structure comprises an upper deflection structure disposed above the upper portion of the windings and a lower deflection structure disposed above the lower portion of the windings and below the upper portion of the windings. The upper deflection structure comprises a first impact surface configured to receive the cooling fluid from the first cooling fluid conduit and to spread the cooling fluid, and the upper deflection structure being configured to supply the cooling fluid spread by the first impact surface to the upper portion of the windings. The lower deflection structure comprises a second impact surface configured to receive the cooling fluid from the second cooling fluid conduit to spread the cooling fluid, the lower deflection structure being configured to supply the cooling fluid spread by the first impact surface to the upper portion of the windings. The upper deflection structure is arced around at least a portion of the upper portion of the windings. The motor cooling fluid distribution structure further comprises a gutter structure disposed below the upper portion of the windings and above the lower portion of the windings. The gutter structure comprises a partial annulus structure configured to catch the cooling fluid from the upper deflection structure passing through the upper portion of the windings.

In yet another exemplary embodiment, a vehicle comprises a plurality of wheels; a rechargeable energy storage system; and a vehicle motor assembly configured to receive power from the rechargeable energy storage system to rotate one or more of the plurality of wheels. The vehicle motor assembly comprises a stator assembly comprising windings; a cooling fluid conduit configured to supply cooling fluid to cool the windings; and a motor cooling fluid distribution structure. The motor cooling fluid distribution structure comprises a deflection structure disposed above at least a portion of the windings. The deflection structure comprises an impact surface configured to receive the cooling fluid from the cooling fluid conduit and to spread the cooling fluid. The deflection structure is configured to supply the cooling fluid spread by the impact surface to the windings.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a left side view of a vehicle including an electric motor having a motor cooling fluid distribution structure according to one or more embodiments;

FIG. 2 is a perspective view of an electric motor according to one or more embodiments;

FIG. 3 is a perspective view of upper deflection structures of a motor cooling fluid distribution structure according to one or more embodiments;

FIG. 4A is a perspective view of a lower deflection structure of a motor cooling fluid distribution structure according to one or more embodiments;

FIG. 4B is a perspective view of a lower deflection structure of a motor cooling fluid distribution structure according to one or more embodiments;

FIG. 5 is a perspective view of a stator assembly having a motor cooling fluid distribution structure according to one or more embodiments;

FIG. 6 is a perspective view of a motor cooling fluid distribution structure according to one or more embodiments with a portion of the winding of the stator assembly;

FIG. 7 is a perspective view of a motor cooling fluid distribution structure according to one or more embodiments;

FIG. 8 is a side view of a motor cooling fluid distribution structure according to one or more embodiments;

FIG. 9 is a perspective view of a motor cooling fluid distribution structure according to one or more embodiments with a portion of the winding of the stator assembly and cooling fluid conduits;

FIG. 10 is a perspective view of an upper deflection structure according to one or more embodiments;

FIG. 11A is a cross-sectional view of the upper deflection structure of FIG. 10 taken at line 11A-11A;

FIG. 11B is a cross-sectional view of the upper deflection structure of FIG. 10 taken at line 11B-11B;

FIG. 12 is a perspective view of an upper deflection structure according to one or more embodiments; and

FIG. 13 is a cross-sectional view of the upper deflection structure of FIG. 12 taken at line 13-13.

### DETAILED DESCRIPTION

The following description is merely exemplary in nature and is not intended to limit the present disclosure, its application or uses. It should be understood that throughout the drawings, corresponding reference numerals indicate like or corresponding parts and features.

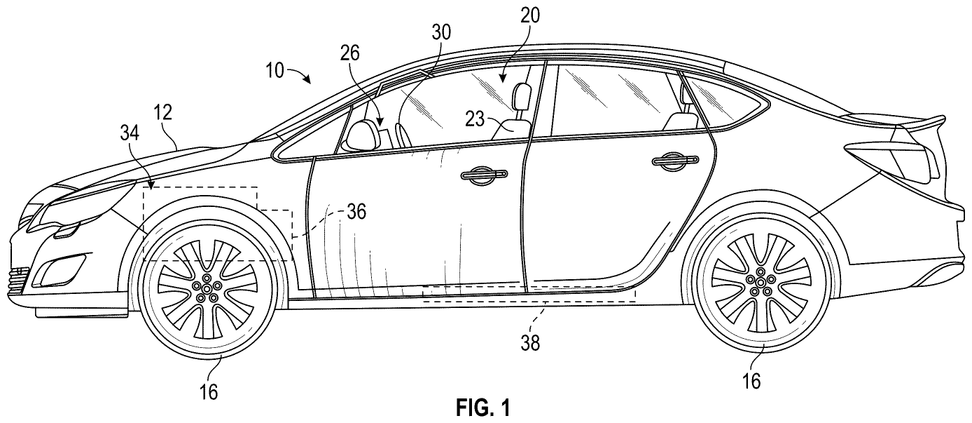

A vehicle 10 according to a non-limiting example is shown in FIG. 1. The vehicle 10 includes a body 12 supported on a plurality of wheels 16. One or more of the plurality of wheels 16 are steerable. The body 12 defines, in part, a passenger compartment 20 having seats 23 positioned behind a dashboard 26. A steering control 30 is arranged between seats 23 and a dashboard 26. The steering control 30 is operated to control orientation of one or more of the steerable wheel(s) 16.

The vehicle 10 includes an electric motor 34 connected to a system of gears 36 that provides power to one or more of the plurality of wheels 16. The electric motor 34 may be a prime driver of the vehicle or may be disposed in conjunction with an engine in a hybrid configuration. A rechargeable energy storage system 38 may be arranged in the body 12 to provide power to the electric motor 34. While specific locations are shown for the electric motor 34, the system of gears 36, and the rechargeable energy storage system 38 in FIG. 1, these locations are merely exemplary and not limiting, and locations of these structures may vary.

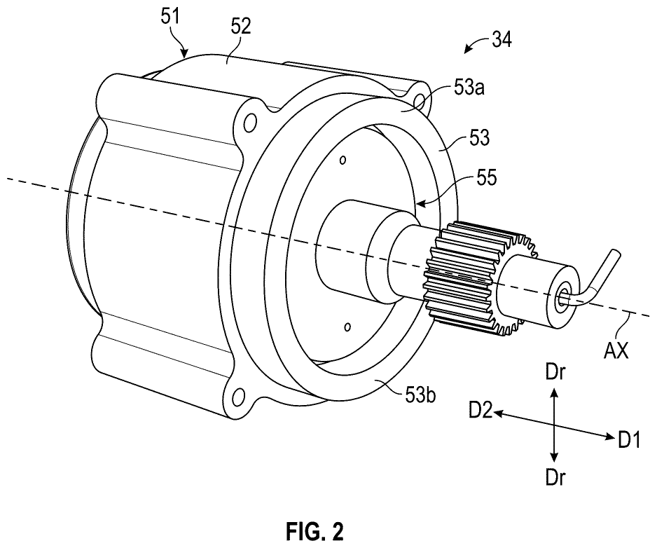

A perspective view of an electric motor 34 according to a non-limiting example is shown in FIG. 2. The electric motor 34 may include a stator assembly 51 disposed around a rotor assembly 55. The stator assembly 51 may include a stator body 52 and windings 53 disposed within the stator body 52. The windings 53 have an upper portion 53a and a lower portion 53b, as illustrated in FIG. 2. As a non-limiting example, the upper portion 53a may be an upper half of the windings 53 and the lower portion 53b may be a lower half of the windings 53. As a non-limiting example, the windings 53 may be copper windings. The stator body 52 and the windings 53 may be stationary annular structures defining a space therein in which at least a portion of the rotor assembly 55 is rotatably disposed. The rotor assembly 55 is configured to rotate when the windings 53 are energized by the rechargeable energy storage system 38. Rotation of the rotor assembly 55 may be translated to the one or more of the wheels 16. The electric motor 34 defines a rotation axis Ax about which the rotor assembly 55 rotates. A first direction D1 and a second direction D2 may extend along the rotation axis Ax, and radial directions Dr extend perpendicular to the rotation axis Ax.

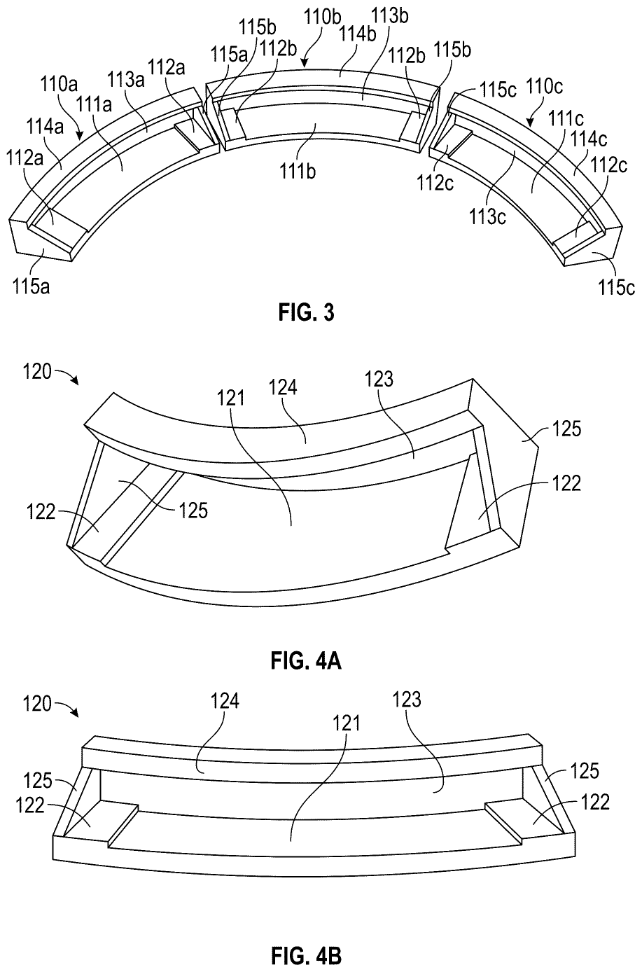

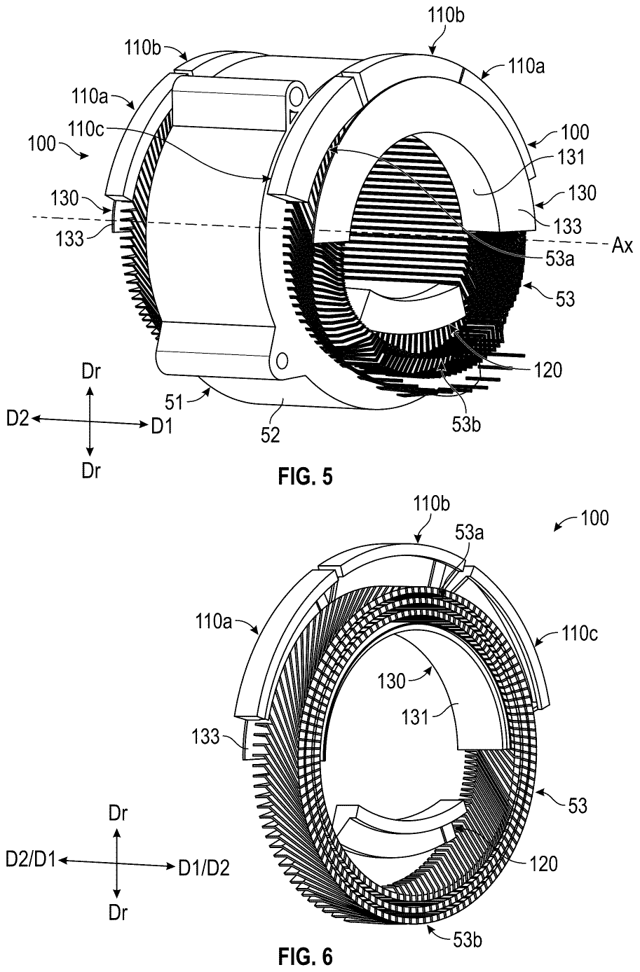

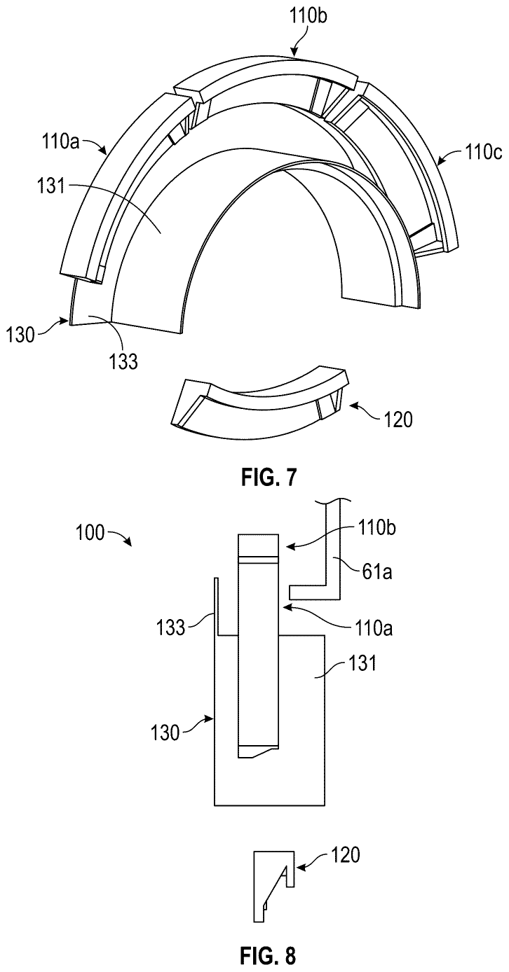

Referring to FIG. 3, upper deflection structures 110a, 110b, 110c of a motor cooling fluid distribution structure 100 (see FIGS. 5-9) according to one or more embodiments are shown. As a non-limiting example, the upper deflection structures 110a, 110b, 110c may be impact plates which are plate-shaped structures configured to receive an impact of cooling fluid. Each of the upper deflection structures 110a, 110b, 110c may be structured as an arc, and may be arranged adjacently along a circumferential direction. Each of the upper deflection structures 110a, 110b, 110c may include an impact wall 111a, 111b, 111c, stepped portions 112a, 112b, 112c and side walls 115a, 115b, 115c on either ends of the impact wall 111a, 111b, 111c, and an upper wall 113a, 113b, 113c on an upper end of the impact wall 111a, 111b, 111c. A lip 114a, 114b, 114c may be formed at an end of the upper wall 113a, 113b, 113c opposite the impact wall 111a, 111b, 111c. As shown in FIG. 3, the upper wall 113a, 113b, 113c may be arced such that an upper surface thereof is convex. The impact wall 111a, 111b, 111c may define an impact surface.

A lower deflection structure 120 of a motor cooling fluid distribution structure 100 (see FIGS. 5-9) according to one or more embodiments is shown in FIGS. 4A and 4B. As a non-limiting example, the lower deflection structure 120 may be an impact plate. The lower deflection structure 120 may be structured as an arc. The lower deflection structure 120 may include an impact wall 121, stepped portions 122 and side walls 125 on either ends of the impact wall 121, and an upper wall 123 on an upper end of the impact wall 121. A lip 124 may be formed at an end of the upper wall 123 opposite the impact wall 121. As shown in FIGS. 4A and 4B, the upper wall 123 may be arced such that an upper surface thereof is concave. The impact wall 121 may define an impact surface.

As shown in FIG. 5, a motor cooling fluid distribution structure 100 may be disposed on each side of the stator assembly 51 along the rotation axis Ax. Alternatively, the motor cooling fluid distribution structure 100 may be disposed on only one side of the stator assembly 51 along the rotation axis Ax. As shown in FIGS. 5-9, the motor cooling fluid distribution structure 100 may include upper deflection structures 110a, 110b, 110c, a lower deflection structure 120, and a gutter structure 130. As a non-limiting example, the motor cooling fluid distribution structure 100 may include three upper deflection structures 110a, 110b, 110c and one lower deflection structure 120. However, the motor cooling fluid distribution structure 100 may include any number of upper deflection structures 110a, 110b, 110c and lower deflection structures 120. According to one or more embodiments, the motor cooling fluid distribution structure 100 may include only the upper deflection structures 110a, 110b, 110c or only the lower deflection structures 120. As shown in FIGS. 5 and 6, the upper deflection structures 110a, 110b, 110c may be disposed above an upper portion 53a of the windings 53 and the lower deflection structure may be disposed above a lower portion 53b of the windings 53.

The gutter structure 130 may include a partial annulus structure 131 and a radial wall 133 on an end of the partial annulus structure 131. The partial annulus structure 131 may be disposed on an inner side of the windings 53 along the radial direction Dr. As shown in FIGS. 5 and 6, an upper portion 53a of the windings 53 may be disposed between the upper deflection structures 110a, 110b, 110c and the partial annulus structure 131 along the radial direction Dr. As shown in FIG. 8, the upper deflection structures 110a, 110b, 110c may be spaced apart from the radial wall 133. The partial annulus structure 131 may be shaped as a half-annulus.

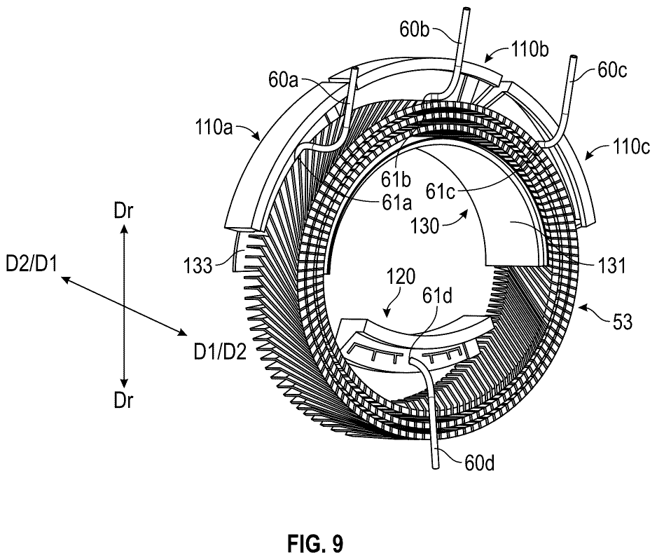

As shown in FIG. 9, a plurality of cooling fluid conduits 60a, 60b, 60c, 60d may be positioned with respect to the motor cooling fluid distribution structure 100 such that fluid outlets 61a, 61b, 61c, 61d of the cooling fluid conduits 60a, 60b, 60c, 60d respectively face the impact walls 111a, 111b, 111c of the upper deflection structures 110a, 110b, 110c or the impact wall 121 of the lower deflection structures 120. According to one or more embodiments, the cooing fluid conduits 60a, 60b, 60c, 60d may be fluid jets. According to one or more embodiments, the cooling fluid may be oil.

The cooling fluid conduits 60a, 60b, 60c, 60d may spray cooling fluid onto the impact walls 111a, 111b, 111c, 121 via the fluid outlets 61a, 61b, 61c, 61d. The cooling fluid impinging on the impact walls 111a, 111b, 111c, 121 may be deflected by the impact walls 111a, 111b, 111c, 121 and spread in radial and circumferential directions from the point of impact on the impact walls 111a, 111b, 111c, 121, but may be constrained in an outer radial direction via the upper wall 113a, 113b, 113c, 123, and in circumferential directions via stepped portions 112a, 112b, 112c, 122 and side walls 115a, 115b, 115c, 125. The cooling fluid impinging on the impact walls 111a, 111b, 111c, 121 may be spread as a film circumferentially across the impact walls 111a, 111b, 111c, 121 prior to flowing downward onto the windings 53. Thus, the motor cooling fluid distribution structure 100 may allow for cooling fluid to be evenly distributed to the windings 53 of the stator assembly 51 of the motor 34 in a controlled manner, which may achieve more uniform and improved cooling.

The cooling fluid may pass through the windings 53, thereby cooling the windings 53, and the cooling fluid from the upper deflection structures 110a, 110b, 110c may flow onto the partial annulus structure 131 and flow around the partial annulus structure 131 downward into a sump (not shown) with the radial wall 133 contains the cooling fluid in the first direction D1 or the second direction D2 away from the stator assembly 41, while the cooling fluid from the lower deflection structure 120 may flow into the sump (not shown).

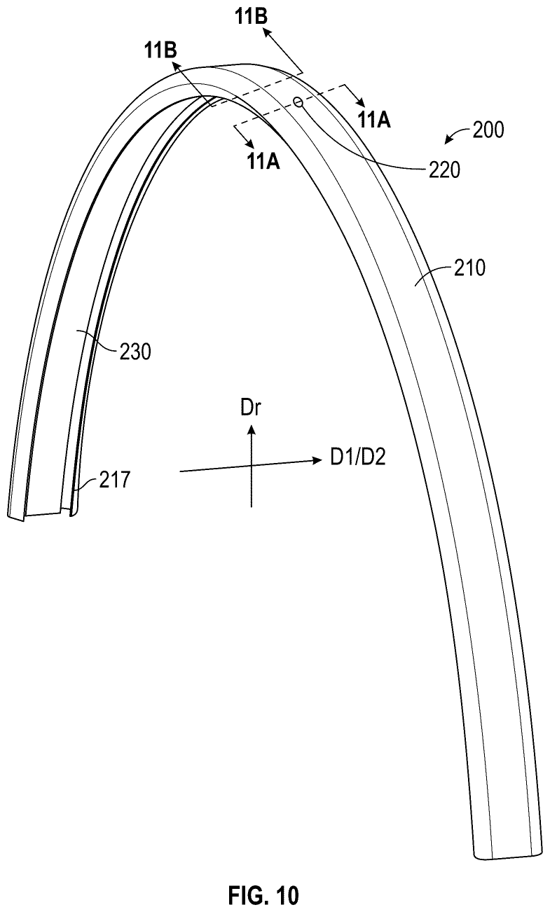

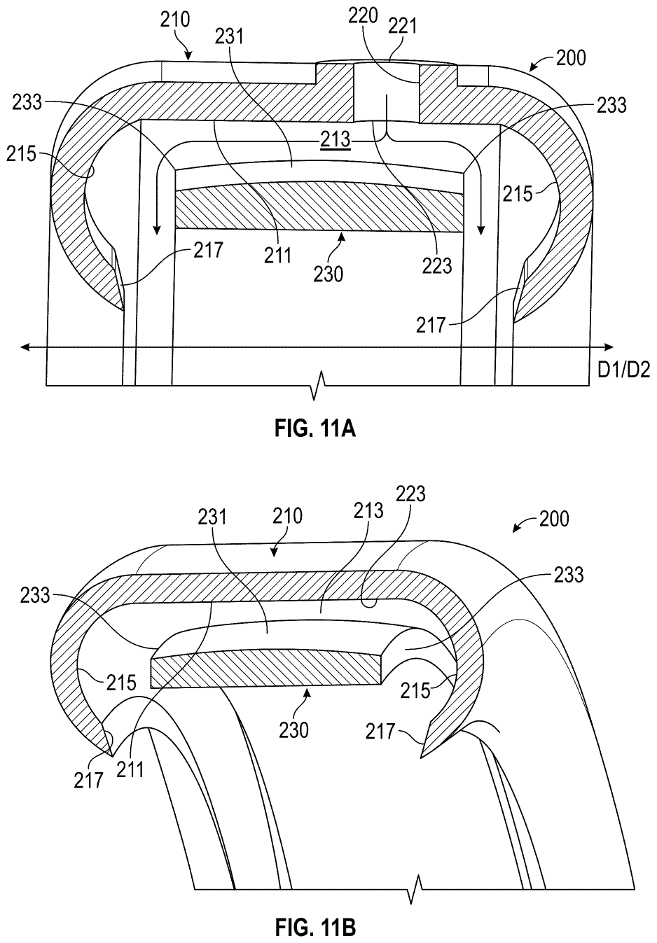

An upper deflection structure 200 according to one or more embodiments is shown in FIGS. 10, 11A, and 11B. The upper deflection structure 200 may be positioned similarly to the upper deflection structures 110a, 110b, 110c with respect to the windings 53 as described above.

The upper deflection structure 200 may be shaped as a partial ring. As a non-limiting example, the upper deflection structure 200 may be a half-ring that has a half-circle shape when viewed along the first direction D1 or the second direction D2. The upper deflection structure 200 include an outer body 210 having a fluid inlet opening 220 and an inner body 230 disposed on an inner side of the outer body 210 along the radial direction Dr. As shown in the cross-sections of FIGS. 11A and 11B, the outer body 210 includes an axial wall 211, curved radial walls 215 extending from the axial wall 211, and terminal edges 217 at radially inner ends of the curved radial walls 215 that together define a partially enclosed space 213 in which the inner body 230 is disposed. The fluid inlet opening 220 may extend through the axial wall 211 of the outer body 210 in the radial direction Dr from an inlet end 221 to an outlet end 223. The inner body 230 may include an impact surface 231 on an upper surface thereof that extends along the first and second directions D1, D2 to axial edges 233. The impact surface 231 may be convexly curved when viewed in a circumferential direction.

Although FIG. 11A shows the fluid inlet opening 220 positioned offset from an axial central position of the inner body 230, according to one or more embodiments, the fluid inlet opening 220 may be positioned directly outside the axial central position of the inner body 230 such that the outlet end 223 of the fluid inlet opening 220 is positioned directly over a uppermost portion of the impact surface 231.

A cooling fluid conduit (not shown) similar to the cooling fluid conduits 60a, 60b, 60c, 60d shown in FIG. 9 may be coupled to an inlet end 221 of the fluid inlet opening 220, or may extend at least partially through the fluid inlet opening 220, such that cooling fluid may be introduced into the partially enclosed space 213 of the outer body 210 and impinge onto the impact surface 231. The cooling fluid impinging onto the impact surface 231 may be deflected by the impact surface 231 and spread axially and circumferentially over the impact surface 231, with the axially spread cooling fluid impinging on the curved radial walls 215 and flowing downward from the terminal edges 217 onto the windings 53 to cool the windings 53. According to one or more embodiments, the upper deflection structure 200 may be employed in conjunction with the gutter structure 130 and/or the lower deflection structure 120 shown in FIGS. 4A-9 or may be employed without the gutter structure 130 or the lower deflection structure 120.

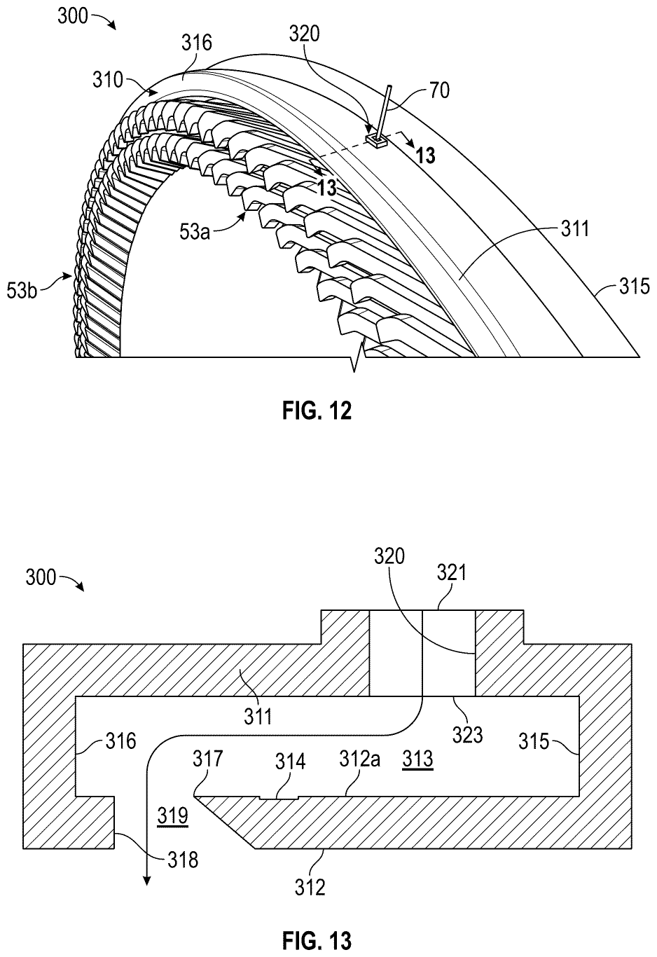

In an embodiment, an upper deflection structure 300 is shown in FIGS. 12 and 13. The upper deflection structure 300 includes a main body 310 having an outer axial wall 311, an inner axial wall 312, and side walls 315, 316 that define a partially enclosed space 313 therein. A fluid inlet opening 320 may be formed through the outer axial wall 311, extending from an inlet end 321 to an outlet end 323. The inner axial wall 312 may define an impact surface 312a, and the outlet end 323 may face the impact surface 312a of the inner axial wall 312. The inner axial wall 312 may extend between the side walls 315, 316 with a circumferential opening 319 formed therein between opening edges 317, 318.

A cooling fluid conduit 70 may be coupled to the inlet end 321 of the fluid inlet opening 320, or may extend at least partially through the fluid inlet opening 320, such that cooling fluid may be introduced into the partially enclosed space 313 of the main body 310 and impinge onto the impact surface 312a. The cooling fluid impinging onto the impact surface 312a may be deflected by the impact surface 312a and spread axially and circumferentially over the impact surface 312a and towards the circumferential opening 319. The cooling fluid flows through the circumferential opening 319 downward onto the windings 53 to cool the windings 53. A recess 314 may be formed on the impact surface 323a that interrupts surface tension of the cooling fluid to improve the spreading of the cooling fluid. Cooling fluid that passes over the circumferential opening 319 may be stopped by the side wall 316 and flow back towards the circumferential opening 319 and through the circumferential opening 319 onto the windings 53. According to one or more embodiments, the upper deflection structure 300 may be employed in conjunction with the gutter structure 130 and/or the lower deflection structure 120 shown in FIGS. 4A-9 or may be employed without the gutter structure 130 or the lower deflection structure 120.

As non-limiting examples, the upper deflection structures 110a, 110b, 110c, 200, 300 may be mounted on a motor housing (not shown) along the radial direction Dr and/or along the first or second directions D1, D2, and/or may be mounted on the stator assembly 51. As non-limiting examples, the gutter structure 130 may be mounted via the radial wall 133 on the motor housing (not shown) along the radial direction Dr and/or along the first or second directions D1, D2. As non-limiting examples, the lower deflection structure 120 may be mounted on a motor housing (not shown) along the first or second directions D1, D2. As non-limiting examples, the cooling fluid conduits 60a, 60b, 60c, 60d, 70 may be mounted on the motor housing (not shown) along the radial direction Dr.

While the upper deflection structures 110a, 110b, 110c, 200, 300, the lower deflection structure 120, and the gutter structure 130 are shown as separate structures, according to one or more embodiments, one or more of these structures may be formed together (e.g., by connecting them together via welding). As a non-limiting example, these structures may be combined into a single structure.

While the cooling fluid conduits 60a, 60b, 60c, 60d, 70 are shown, according to one or more embodiments, cooling fluid conduits may be formed within the stator assembly 51 (e.g., openings formed in the stator body 52 that sprays the cooling fluid).

According to one or more embodiments, the upper deflection structures 110a, 110b, 110c, 200, 300, the lower deflection structure 120, and the gutter structure 130 may be formed as extensions of the stator body 52.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A motor assembly for a vehicle, comprising:
a stator assembly comprising windings;
a cooling fluid conduit configured to supply cooling fluid to cool the windings; and
a motor cooling fluid distribution structure,
wherein the motor cooling fluid distribution structure comprises a deflection structure disposed above at least a portion of the windings,
wherein the deflection structure comprises an impact surface configured to receive the cooling fluid from the cooling fluid conduit and to spread the cooling fluid, and
wherein the deflection structure is configured to supply the cooling fluid spread by the impact surface to the windings.

2. The motor assembly of claim 1, wherein the cooling fluid conduit comprises a fluid outlet facing the impact surface.

3. The motor assembly of claim 1, wherein the deflection structure further comprises an upper wall above the impact surface and side walls on circumferential sides of the impact surface.

4. The motor assembly of claim 3, wherein the upper wall comprises a lip on an end thereof.

5. The motor assembly of claim 1, wherein the deflection structure extends circumferentially about at least a portion of the windings.

6. The motor assembly of claim 1, wherein the deflection structure is an upper deflection structure disposed above an upper portion of the windings and is configured to supply the cooling fluid spread by the impact surface to the upper portion of the windings.

7. The motor assembly of claim 6,
wherein the motor cooling fluid distribution structure further comprises a lower deflection structure disposed above a lower portion of the windings and below the upper portion of the windings,
wherein the lower deflection structure comprises an impact surface configured to receive the cooling fluid from another cooling fluid conduit to spread the cooling fluid, and
wherein the lower deflection structure is configured to supply the cooling fluid spread by the impact surface to the lower portion of the windings.

8. The motor assembly of claim 6,
wherein the motor cooling fluid distribution structure further comprises a gutter structure disposed below the upper portion of the windings, and
wherein the gutter structure comprises a partial annulus structure configured to catch the cooling fluid from the upper deflection structure passing through the upper portion of the windings.

9. The motor assembly of claim 1, wherein the deflection structure is shaped as a partial ring around the upper portion of the windings.

10. The motor assembly of claim 9, wherein the deflection structure comprises an outer body defining a partially enclosed space therein, and an inner body disposed within the partially enclosed space and defining the impact surface.

11. The motor assembly of claim 10, wherein the impact surface is curved when viewed along a circumferential direction of the partial ring.

12. The motor assembly of claim 10, wherein the outer body comprises a curved radial wall facing an edge of the impact surface.

13. The motor assembly of claim 10, wherein a fluid inlet opening is defined through a wall of the outer body.

14. The motor assembly of claim 13, wherein an outlet end of the fluid inlet opening faces the impact surface.

15. The motor assembly of claim 9,
wherein the deflection structure defines a partially enclosed space therein, with the impact surface defining at least a portion of the partially enclosed space, and
wherein an opening configured to supply the cooling fluid to the windings is formed in the impact surface.

16. The motor assembly of claim 1, wherein the impact surface comprises a recess configured to interrupt a surface tension of the cooling fluid.

17. The motor assembly of claim 13, wherein the cooling fluid conduit is coupled to the fluid inlet opening.

18. The motor assembly of claim 1, wherein the cooling fluid conduit is configured to supply a fluid jet to the impact surface.

19. A motor assembly for a vehicle, comprising:
a stator assembly comprising windings, the windings comprising an upper portion and a lower portion;
a first cooling fluid conduit configured to providing cooling fluid to cool the upper portion of the windings;
a second cooling fluid conduit configured to supply the cooling fluid to cool the lower portion of the windings; and
a motor cooling fluid distribution structure,
wherein the motor cooling fluid distribution structure comprises an upper deflection structure disposed above the upper portion of the windings and a lower deflection structure disposed above the lower portion of the windings and below the upper portion of the windings,
wherein the upper deflection structure comprises a first impact surface configured to receive the cooling fluid from the first cooling fluid conduit and to spread the cooling fluid, and the upper deflection structure being configured to supply the cooling fluid spread by the first impact surface to the upper portion of the windings,
wherein the lower deflection structure comprises a second impact surface configured to receive the cooling fluid from the second cooling fluid conduit to spread the cooling fluid, the lower deflection structure being configured to supply the cooling fluid spread by the first impact surface to the upper portion of the windings,
wherein the upper deflection structure is arced around at least a portion of the upper portion of the windings,
wherein the motor cooling fluid distribution structure further comprises a gutter structure disposed below the upper portion of the windings and above the lower portion of the windings, and
wherein the gutter structure comprises a partial annulus structure configured to catch the cooling fluid from the upper deflection structure passing through the upper portion of the windings.

20. A vehicle comprising:
a plurality of wheels;
a rechargeable energy storage system; and
a vehicle motor assembly configured to receive power from the rechargeable energy storage system to rotate one or more of the plurality of wheels, the vehicle motor assembly comprising:
a stator assembly comprising windings;
a cooling fluid conduit configured to supply cooling fluid to cool the windings; and
a motor cooling fluid distribution structure,
wherein the motor cooling fluid distribution structure comprises a deflection structure disposed above at least a portion of the windings,
wherein the deflection structure comprises an impact surface configured to receive the cooling fluid from the cooling fluid conduit and to spread the cooling fluid, and
wherein the deflection structure is configured to supply the cooling fluid spread by the impact surface to the windings.
